(19) United States
(12) Patent Application Publication
(10) Pub. No.: US 2024/0059853 A1
(43) Pub. Date: Feb. 22, 2024

(54) OXYGEN BARRIER COATING COMPOSITION AND COATING SOLUTION, COATING LAYER, AND PRODUCT COMPRISING THE SAME

(71) Applicant: Nano and Advanced Materials Institute Limited, Hong Kong (HK)

(72) Inventors: Yan Yan LAM, Hong Kong (HK); Pui Sze LAU, Hong Kong (HK); Kwan Shing CHAN, Hong Kong (HK); Ka Yee HO, Hong Kong (HK)

(21) Appl. No.: 18/448,970

(22) Filed: Aug. 14, 2023

Related U.S. Application Data
(60) Provisional application No. 63/399,717, filed on Aug. 21, 2022.

(51) Int. Cl. C08J 7/048; C08J 7/04; C08K 7/18; C08K 5/053; C09D 7/20; C09D 129/04; C08K 5/092; C09D 7/63; C09D 7/61; C08J 7/18

(52) U.S. Cl. CPC C08J 7/048; C08J 7/0427; C08K 7/18; C08K 5/053; C09D 7/20; C09D 129/04; C08K 5/092; C09D 7/63; C09D 7/61; C08J 7/18; C08J 2329/04; C08J 2367/02; C08J 2305/08; C08K 2201/011; C08K 2201/003; C08K 2201/014

(57) ABSTRACT

An oxygen barrier packaging material is provided. The packaging film includes a substrate polymer formed as a transparent and flexible film. An at least 75 percent light transmissive, oxygen barrier coating is formed on the substrate polymer transparent and flexible film. The oxygen barrier coating is formed from a composition that includes approximately 15 wt % to 35 wt % of a coating polymer in dry weight, approximately 0.1 wt % to 5 wt % of nanoparticles in dry weight, approximately 40 wt % to 75 wt % of a plasticizer in dry weight, and approximately 5 wt % to 20 wt % of a crosslinking agent in dry weight. The nanoparticles in the coating create a convoluted path for oxygen and the coating is stretchable and bendable with the substrate polymer.

### CROSS-REFERENCE TO RELATED APPLICATIONS

The present application claims priority from U.S. provisional patent application Ser. No. 63/399,717 filed Aug. 21, 2022, and the disclosure of which is incorporated herein by reference in its entirety.

### FIELD OF THE INVENTION

The present invention relates to an oxygen barrier coating composition and, more particularly, to a translucent antimicrobial oxygen barrier coating composition and its use as a plastic packaging coating.

### BACKGROUND OF THE INVENTION

Ready-to-eat food often undergoes packaging using various plastic materials such as polyethylene terephthalate (PET), high- or low-density polyethylene (HDPE or LDPE), polyvinyl chloride (PVC), polypropylene (PP), polystyrene (PS), and polycarbonate (PC). However, these plastics alone may not provide the optimal oxygen barrier required to preserve the taste and extend the shelf life of the food. Oxygen exposure leads to the oxidation of fat molecules, resulting in rancidity, as well as the growth of bacteria and mold, leading to food spoilage. To counteract these issues, food manufacturers have resorted to adding preservatives to inhibit fungal and bacterial growth. However, some preservatives are known to cause allergies. Given the increasing demand for preservative-free food due to health concerns, there is a need for alternatives that allow for long-term food storage without the addition of preservatives.

Oxygen scavengers, such as iron-based powders, are sometimes used in food packaging in the form of small sachets. However, these sachets pose a risk of accidental ingestion, particularly for young children. Additionally, oxygen absorbers have limited loading capacity and expire over time. Another approach to prevent oxidation is by controlling the oxygen permeation through the packaging layer. Developing packaging with an effective oxygen barrier layer would be highly desirable for products susceptible to spoilage, eliminating the need for oxygen scavenger sachets. Currently, the industry practice to enhance barrier properties in plastic packaging involves laminating it with polyvinylidene chloride (PVDC), ethylene vinyl alcohol (EVOH), or applying a metalized aluminum layer. PVDC, a transparent thermoplastic with excellent chemical resistance and barrier properties, has raised environmental concerns due to its chlorine content, which can emit dioxins during incineration. As a result, the use of PVDC as a barrier layer has been declining. EVOH's performance is significantly affected by humidity and has limited applicability in flexible packaging. Aluminum foil poses challenges for plastic recycling due to the expensive separation process. To extend the shelf life of packaged products without relying on potentially toxic preservatives and to facilitate plastic recycling, thereby reducing plastic waste, it is imperative to develop a barrier coating that effectively prevents oxygen permeation and is applicable to both flexible and rigid packaging.

Various oxygen barrier coating compositions involving polymers and clay materials have been proposed. For instance, U.S. Pat. No. 9,221,956 B2 titled “Gas barrier coating” discloses a gas barrier coating comprising poly(vinyl alcohol) and/or ethylene-vinyl alcohol copolymer, dispersed clay, and polycarboxylic acid polymer, with clay present in the composition at approximately 35 to 50 wt %. Another patent, U.S. Pat. No. 9,657,195 B2 titled “Aqueous coating agent and gas barrier film” describes an aqueous coating composition containing an aqueous polyurethane resin, a water-soluble polymer, and an inorganic layered mineral, with the inorganic layered mineral at a solid content of 10-30 mass %.

While oxygen barrier compositions can be utilized as a middle layer in a laminated structure, the high concentration of clay minerals significantly reduces the transparency of plastic packaging when applied as surface coatings, thus affecting the appearance of the product. Consequently, there is a need for a nanocomposite oxygen barrier coating composition with antimicrobial properties that can enhance the barrier performance while inhibiting bacterial growth on plastic packaging without compromising its visual appeal. The present invention effectively addresses this need by providing a solution that meets these requirements. The present invention addresses this need.

### SUMMARY OF THE INVENTION

It is an objective of the present invention to provide an oxygen barrier packaging material to solve the aforementioned technical problems.

In accordance with a first aspect of the present invention, the present invention provides an oxygen barrier packaging material, including a substrate polymer transparent and flexible film and an at least 75 percent light transmissive, oxygen barrier coating formed on the substrate polymer transparent and flexible film. The packaging film includes a substrate polymer formed as a transparent and flexible film. The oxygen barrier coating is formed from a composition that includes approximately 15 wt % to 35 wt % of a coating polymer in dry weight, preferably 15 wt % to 25 wt % in dry weight, approximately 0.1 wt % to 5 wt % of nanoparticles in dry weight, preferably 2.5 wt % to 4 wt % in dry weight, approximately 40 wt % to 75 wt % of a plasticizer in dry weight, preferably 60 wt % to 75 wt % in dry weight, and approximately 5 wt % to 20 wt % of a crosslinking agent in dry weight, preferably 5 wt % to 10 wt % in dry weight. The nanoparticles in the coating create a convoluted path for oxygen and the coating is stretchable and bendable with the substrate polymer.

In accordance with one embodiment of the present invention, the coating polymer is selected from chitosan with a molecular weight from 50,000 to 190,000, preferably 50,000 to 100,000, polyvinyl alcohol with a molecular weight from 85,000 to 130,000 and a degree of hydrolysis from 90% to 99%, preferably 89,000 to 120,000 and a degree of hydrolysis from 95% to 99%, or a combination thereof.

In accordance with one embodiment of the present invention, the nanoparticles are selected from silicon dioxide, zinc oxide, nano clay or any combinations thereof, and the nanoparticles have a particle diameter of 5 nm to 100 nm, preferably 50 nm to 70 nm.

In accordance with one embodiment of the present invention, the plasticizer is selected from glycerol, sorbitol or a combination thereof.

In accordance with one embodiment of the present invention, the crosslinking agent is selected from citric acid, malic acid, maleic acid, tartaric acid or combinations thereof.

In accordance with one embodiment of the present invention, the coating is formed from a coating solution comprising the coating composition of claim 1 and a solvent, wherein a weight ratio of the coating composition to the solvent is 1:1 to 1:15, preferably 1:1 to 1:10.

In accordance with one embodiment of the present invention, the solvent is selected from distilled water, deionized water, methanol, ethanol, acetone, ether, or combinations thereof.

In accordance with one embodiment of the present invention, the packaging material exhibits a reduction in oxygen transmission rate of at least 90% compared to the substrate polymer transparent and flexible film without the oxygen barrier coating.

In accordance with one embodiment of the present invention, the oxygen barrier coating has a dry coating thickness approximately 3 μm or less.

In accordance with one embodiment of the present invention, the substrate polymer transparent and flexible film is polyethylene terephthalate or a low-density polyethylene.

In accordance with another embodiment of the present invention, the composition further includes a UV-absorbing agent in a weight percentage of approximately 0.1 wt % to 5 wt % of the dry weight and a colorant in a weight percentage of approximately 0.1 wt % to 5 wt % of the dry weight.

In accordance with one embodiment of the present invention, the substrate polymer transparent and flexible film further includes a print or pattern on its surface, and the print or pattern is applied using a printing process selected from flexographic printing, gravure printing, or digital printing.

In accordance with one embodiment of the present invention, the substrate is flexible plastic film. The substrate is selected from polyethylene terephthalate (PET) and low-density polyethylene (LDPE), wherein the substrate maybe subjected to corona or plasma surface treatment to remove contaminants and improve adhesion of the coating.

In accordance with a second aspect of the present invention, a method of manufacturing the oxygen barrier packaging material is provided.

In accordance with one embodiment of the present invention, the process of producing the oxygen barrier packaging material involves applying a coating solution to the substrate polymer transparent and flexible film. This coating solution includes the composition described above along with a solvent. After coating, the film is then subjected to a drying process, which results in the formation of the oxygen barrier coating on the substrate. Finally, to further enhance the properties of the oxygen barrier, the coating is cured through heat treatment, typically at temperatures ranging from 80° C. to 120° C. This curing process ensures the stability and effectiveness of the oxygen barrier coating, providing the desired barrier properties for the packaging material.

In accordance with one embodiment of the present invention, the barrier coating layer has 25% or less of a reduction in transmittance in the visible light region from 400 to 700 nm as compared to the substrate without coating.

In accordance with a third aspect of the present invention, the present invention provides an oxygen barrier coating composition that includes (dry weight prior to mixing with a solvent):
15 wt % to 35 wt % of a polymer in dry weight;
0.1 wt % to 5 wt % of nanoparticles in dry weight;
40 wt % to 75 wt % of a plasticizer in dry weight; and
5 wt % to 20 wt % of a crosslinking agent in dry weight.

In some embodiments, the composition includes 15 wt % to 25 wt % of a polymer in dry weight, 2.5 wt % to 4 wt % of nanoparticles in dry weight, 60 wt % to 75 wt % of a plasticizer in dry weight, and 5 wt % to 10 wt % of a crosslinking agent in dry weight.

In accordance with another embodiment of the present invention, the molecular weight refers to weight-average molecular weight.

In accordance with one embodiment of the present invention, the nanoparticles in the coating create a convoluted path for oxygen when the coating composition is disposed on a substrate and wherein the formed coating is bendable and stretchable, and the barrier coating composition provides an oxygen barrier property of at least 90% reduction in oxygen transmission rate (OTR) for the coated substrate.

In accordance with one embodiment of the present invention, the coating polymer is selected from chitosan with a molecular weight from 50,000 to 190,000, polyvinyl alcohol with molecular weight from 85,000 to 130,000 and a degree of hydrolysis from 90% to 99% or a combination thereof.

In accordance with one embodiment of the present invention, the nanoparticles are selected from silicon dioxide, zinc oxide, nano clay or combinations thereof, and the nanoparticle has a particle diameter of 5 nm to 100 nm. The nanoparticles increase a convoluted diffusion pathway of oxygen through the coating layer, slowing down the diffusion rate and consequently reducing the oxygen transmission rate. The addition of metal oxide nanoparticles can further provide antimicrobial activity against pathogenic bacteria, particularly when zinc oxide particles are used.

In accordance with one embodiment of the present invention, the nano clay may be, but is not limited to, halloysite, montmorillonite, kaolinite or allophane. In one embodiment, the particle diameter may be 30 nm to 70 nm, preferably 50 nm to 70 nm.

In accordance with one embodiment of the present invention, the plasticizer is selected from glycerol, sorbitol or the combination thereof. The addition of plasticizer increases the flexibility of the coating composition.

In accordance with one embodiment of the present invention, the crosslinking agent is selected from citric acid, malic acid, maleic acid, tartaric acid or combinations thereof.

In accordance with one embodiment of the present invention, the coating is formed into a coating solution including the coating composition and a solvent, more particularly, a weight ratio of the coating composition to the solvent is 1:1 to 1:15 or 1:1 to 1:10.

In accordance with one embodiment of the present invention, the solvent is selected from distilled water, deionized water, methanol, ethanol, acetone, ether, or combinations thereof.

In accordance with another embodiment of the present invention, the coating solution is a homogeneous solution.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Embodiments of the invention are described in more details hereinafter with reference to the drawings, in which:

FIG. 1 illustrates scanning electron micrographs of the barrier coating layer of Example 1A;

FIG. 2 illustrates the transmittance in visible light region 400 to 700 nm of plain and coated PET film Example 1A, in which the dashed line represents the transmittance with 15% difference from the lowest transmittance of plain PET;

FIG. 3 illustrates scanning electron micrographs of the barrier coating layer of Example 2A;

FIG. 4 illustrates the transmittance in visible light region 400 to 700 nm of plain and coated LDPE film Example 2A, in which the dashed line represents the transmittance with 15% difference from the lowest transmittance of plain LDPE;

FIG. 5 schematically depicts the layered structure of the coating and the convoluted path for oxygen transmission in the coating; and

FIG. 6 is a photograph of a plastic packaging material with the coating of the present invention formed thereon.

### DETAILED DESCRIPTION

In the following description, compounds, materials, and/or methods of a translucent antimicrobial oxygen barrier coating composition for manufacturing plastic packaging material and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

The present invention is directed to an oxygen barrier packaging material, which is designed to effectively preserve the freshness and shelf life of packaged products. The packaging material comprises a substrate polymer transparent and flexible film, which serves as the base structure for the packaging and provides the necessary flexibility and transparency for displaying the packaged contents.

To enhance the oxygen barrier properties of the packaging material, an oxygen barrier coating is applied onto the substrate film. This oxygen barrier coating is formed from a specific composition, which includes various components in precise dry weight percentages. The composition comprises approximately 15 wt % to 35 wt % of a coating polymer, which may be chosen from materials such as chitosan, polyvinyl alcohol, or a combination thereof.

Additionally, the composition contains approximately 0.1 wt % to 5 wt % of nanoparticles, including materials like silicon dioxide, zinc oxide, nano clay, or combinations thereof. The nanoparticles play a critical role in the coating, creating a convoluted path for oxygen molecules and thereby significantly reducing the permeability of oxygen through the material.

The oxygen barrier coating is also designed to be stretchable and bendable, allowing it to adapt and conform to the movements and deformations of the substrate polymer film. This characteristic ensures that the packaging material remains flexible and resistant to damage during handling and use.

Moreover, the composition includes approximately 40 wt % to 75 wt % of a plasticizer, which may consist of glycerol, sorbitol, or a combination of these materials. The plasticizer contributes to the overall flexibility and pliability of the oxygen barrier coating.

Furthermore, the composition incorporates approximately 5 wt % to 20 wt % of a crosslinking agent, which may be chosen from materials such as citric acid, malic acid, maleic acid, tartaric acid, or combinations thereof. The crosslinking agent aids in forming strong chemical bonds within the coating, enhancing its structural integrity and durability.

The oxygen barrier packaging material also exhibits a high degree of light transmittance, with an at least 75 percent transparency, ensuring that the packaged products remain visually appealing to consumers.

In addition to the core composition, the packaging material may further include various additives to enhance its functionality and appearance. These additives may include a UV-absorbing agent, and a colorant, each present in specific weight percentages of approximately 0.1 wt % to 5 wt % of the dry weight.

The term “UV-absorbing agent” used herein refers to a chemical compound or substance incorporated into the oxygen barrier packaging material to absorb and dissipate ultraviolet (UV) radiation. UV-absorbing agents are utilized to protect the packaged products from the harmful effects of UV light, which can lead to degradation and deterioration of the contents. These agents act as a shield, preventing UV radiation from penetrating the packaging and reaching the products, thereby preserving their quality and integrity.

The term “colorant” used herein refers to a pigment, dye, or additive incorporated into the oxygen barrier packaging material to impart color or hue to the material. Colorants are employed to enhance the visual appearance of the packaging and the products contained within. By introducing specific colors or shades, the packaging material can be tailored to attract consumers and communicate brand identity. Colorants used in the packaging material offer a wide range of possibilities for creating appealing and distinctive designs.

The manufacturing process of the oxygen barrier packaging material involves coating the substrate polymer transparent and flexible film with a coating solution containing the specified composition and a solvent. The coated film is then dried, resulting in the formation of the oxygen barrier coating on the substrate film. To further enhance the barrier properties, the coating is cured through heat treatment at temperatures ranging from 80° C. to 120° C.

The resulting oxygen barrier packaging material effectively reduces the transmission rate of oxygen, leading to increased preservation of the packaged products' freshness and extended shelf life. The dry coating thickness of the oxygen barrier coating is approximately 3 μm or less, ensuring that the material remains flexible, transparent, and visually appealing.

The substrate polymer transparent and flexible film used in the packaging material may be composed of materials such as polyethylene terephthalate or low-density polyethylene, each offering excellent transparency and flexibility.

Moreover, the substrate film may also be customized with various prints or patterns using printing processes like flexographic printing, gravure printing, or digital printing, allowing for unique and eye-catching packaging designs.

The product may be, but is not limited to, a plastic wrapper, a plastic bag, a plastic vessel.

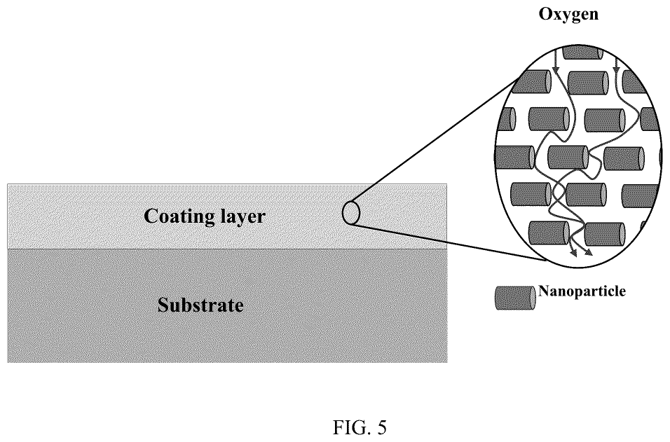

As seen in FIG. 5, the layered structure of the nanoparticles creates a convoluted pathway for oxygen transmission. As a result of this convoluted pathway, oxygen permeation through the coating and the plastic substrate is reduced by approximately 90 percent. In other embodiments, the oxygen permeation through the coated plastic substrate is reduced by approximately 80 percent. In other embodiments, the oxygen permeation through the coated plastic substrate is reduced by approximately 70 percent.

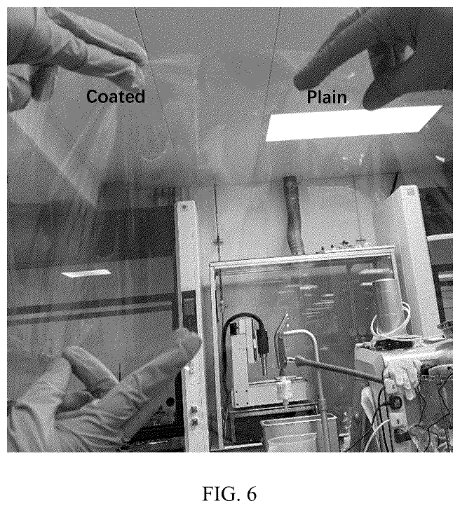

As seen in FIG. 6, the coated plastic substrate is translucent such that food packed with the packaging can easily be seen by the consumer. The coated packaging has at least 75 of the transmittances of an uncoated substrate, including at least 80 percent and at least 85 percent of the transmittance of visible light from 400 to 700 nm as compared to the substrate packaging without coating.

In summary, the oxygen barrier packaging material described herein offers an effective and versatile solution for preserving the quality and freshness of packaged goods while maintaining flexibility, transparency, and visual appeal. Additionally, the unique combination of ingredients and manufacturing process provides a highly desirable oxygen barrier coating that contributes to reduced waste and enhanced product preservation.

In another aspect, the present invention is directed to a method of manufacturing the oxygen barrier packaging material, involving a series of steps to apply the unique oxygen barrier coating onto the substrate polymer transparent and flexible film. The process ensures the formation of a high-performance barrier layer, which effectively prevents oxygen ingress and enhances the shelf life of packaged products. Below is a detailed description of each step involved in the manufacturing process.

At the onset of the method, the substrate polymer transparent and flexible film is prepared to serve as the foundation for the oxygen barrier. The film's properties make it an excellent candidate for creating a protective packaging that can flexibly accommodate various products.

Next comes the critical step of coating the substrate film with a specially formulated solution. This coating solution incorporates the essential components outlined in claim 1, including the coating polymer, nanoparticles, plasticizer, and crosslinking agent. The synergistic blend of these elements imparts unique attributes to the resulting barrier layer. Additionally, the method allows for the optional inclusion of additives such as UV-absorbing agents, and colorants, which can further enhance the barrier material's functionalities.

The application of the coating solution to the substrate film is executed with precision and uniformity. Various coating techniques, such as spraying, dip coating, or roll coating, are employed to ensure a seamless and even distribution of the solution across the film's surface.

Once the coating process is complete, the coated film undergoes a meticulous drying phase. This step is vital to evaporate the solvent present in the coating solution, leaving behind a solid and well-adhered oxygen barrier. The drying conditions are adjusted to suit the specific solvent used and to achieve the desired properties of the final barrier layer.

With the drying process concluded, the oxygen barrier coating is now fully formed on the substrate film. One of the key advantages of this coating lies in its ability to create a convoluted path for oxygen molecules, significantly reducing the transmission rate of oxygen through the barrier layer. Moreover, the unique stretchable and bendable properties of the coating allow it to seamlessly adjust to the movements and contours of the underlying substrate, making it suitable for various packaging applications.

To further optimize the barrier performance, the final step involves curing the oxygen barrier coating. This curing process involves subjecting the coated film to controlled heat treatment within a specific temperature range (between 80° C. and 120° C.). This thermal treatment fosters crosslinking between the molecules within the coating composition, boosting the barrier layer's stability and durability.

In conclusion, the method for manufacturing the oxygen barrier packaging material combines a systematic approach to coating application, precise drying, and well-controlled curing conditions. The result is a high-quality oxygen barrier that offers exceptional performance, transparency, and flexibility, making it an ideal solution for preserving product freshness and quality while presenting an appealing and eco-friendly packaging option.

Furthermore, the present invention encompasses an innovative oxygen barrier coating composition designed to significantly enhance the packaging industry's capabilities in preserving product freshness and quality. This composition has a blend of essential components that synergistically create an oxygen-impermeable barrier on various substrates, enabling longer shelf lives and increased product stability.

At the core of this oxygen barrier composition lies the coating polymer, which constitutes approximately 15 wt % to 35 wt % of the dry weight. Various options for the coating polymer are disclosed, including chitosan with a molecular weight ranging from 50,000 to 190,000, polyvinyl alcohol with a molecular weight between 85,000 and 130,000, and a degree of hydrolysis from 90% to 99%, or combinations thereof. This selection of coating polymers allows for versatility in catering to different packaging requirements.

The composition further includes nanoparticles, accounting for approximately 0.1 wt % to 5 wt % of the dry weight. These nanoparticles play a pivotal role in forming a convoluted path for oxygen molecules when the coating composition is applied to a substrate. This unique feature effectively restricts oxygen permeation and enhances the barrier's overall performance.

To ensure the coating's flexibility and bendability, the composition comprises a plasticizer in the range of approximately 40 wt % to 75 wt % of the dry weight. The plasticizer component imparts the desired stretchability, making the oxygen barrier coating adaptable to the movements and contours of the substrate and the packaged product.

To reinforce the structural integrity of the oxygen barrier, the composition incorporates a crosslinking agent, accounting for approximately 5 wt % to 20 wt % of the dry weight. The presence of the crosslinking agent fosters strong intermolecular bonds, contributing to the barrier's durability and stability.

Selecting suitable nanoparticles, coating polymers, plasticizers, and crosslinking agents ensures that the final composition achieves optimal barrier properties and mechanical flexibility. This makes the formed coating highly effective in preserving the freshness and quality of packaged products.

To facilitate application, the oxygen barrier coating composition can be formulated into a coating solution. The coating solution consists of the composition combined with an appropriate solvent. The weight ratio of the coating composition to the solvent typically ranges from 1:1 to 1:15, ensuring a well-mixed and homogenous solution.

Various solvents may be employed in the coating solution, including but not limited to distilled water, deionized water, methanol, ethanol, acetone, ether, or combinations thereof. The choice of solvent depends on specific application requirements and considerations of safety, cost, and environmental impact.

In conclusion, the oxygen barrier coating composition disclosed in the present invention presents a robust and versatile solution to enhance product packaging. Its innovative combination of coating polymers, nanoparticles, plasticizers, and crosslinking agents creates an oxygen-impermeable, stretchable, and bendable barrier, offering exceptional protection for packaged products. The ability to formulate the composition into a coating solution further enhances its applicability in various packaging processes, making it a valuable advancement in the field of packaging technology.

### EXAMPLE

### Preparation of Example 1

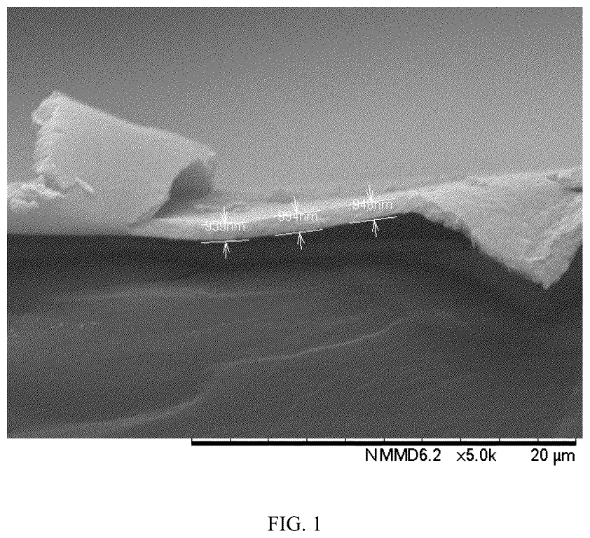

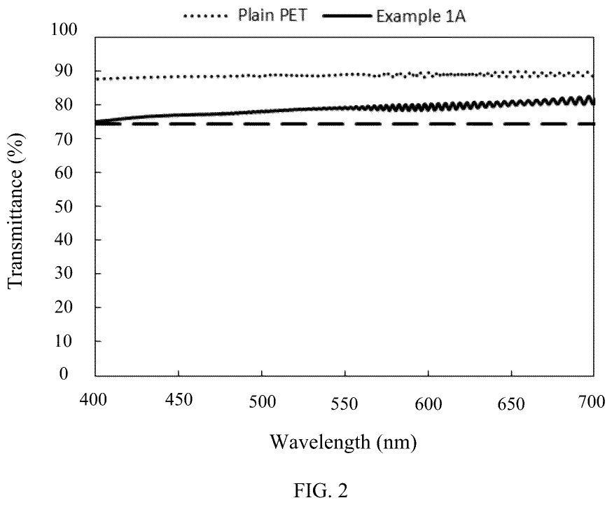

2.5 parts by weight of polyvinyl alcohol (PVA, Mw: 85,000-124,000, degree of hydrolysis: 95.5-96.5%) was mixed with 12.5 part by weight of glycerol. Then 0.6 parts by weight of chitosan (Mw: 50,000-190,000, deacetylated degree: 75-85%) dissolved in acetic acid was added under stirring to obtain a homogeneous mixture M1. 0.5 part by weight of nano clay (particle diameter: 5 to 100 nm) dispersed in 82.6 parts by weight of water and then 1.3 parts by weight of citric acid was added to obtain a mixture M2. The mixture M2 was poured into the mixture M1. The final mixture was homogenized for 2 minutes by using an ultrasound sonicator. Afterwards, the final mixture was further stirred for 3 hours under 80° C. water bath and the coating solution of Example 1 was formed. The coating composition of Example 1 was applied by bar coating on a PET film and cured at 80 to 120° C. to render coated the samples of Example 1A. The oxygen transmission rate (OTR) of Example 1A was reduced by over 98% compared with the plain PET without coating as shown in Table 1. The coating layer of Example 1A had an average film thickness of less than 3 m as observed by scanning electron microscope in FIG. 1. The reduction in transmittance in the visible light region of 400 to 700 nm of the Example 1A was less than 15% compared to the plain PET without coating as shown in FIG. 2.

TABLE 1
Oxygen transmission rate (OTR) of
plain PET film and Example 1A.

| Sample | OTR (cm³/(m² · day)) |
|---|---|
| Plain PET | 61.214 |
| Example 1A | 0.643 |

### Preparation of Example 2

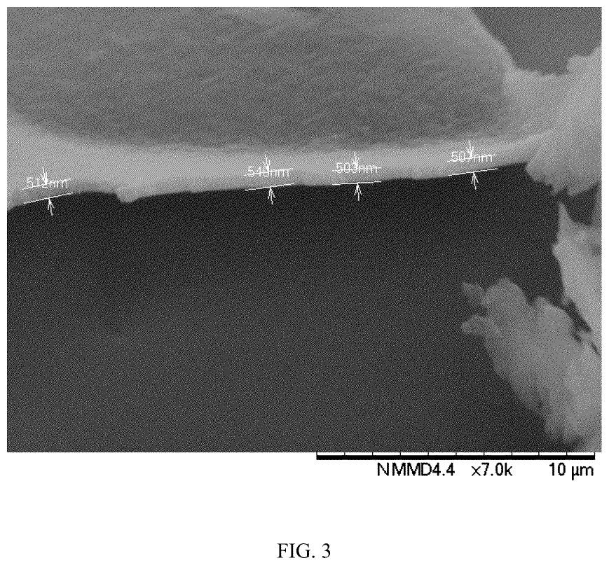

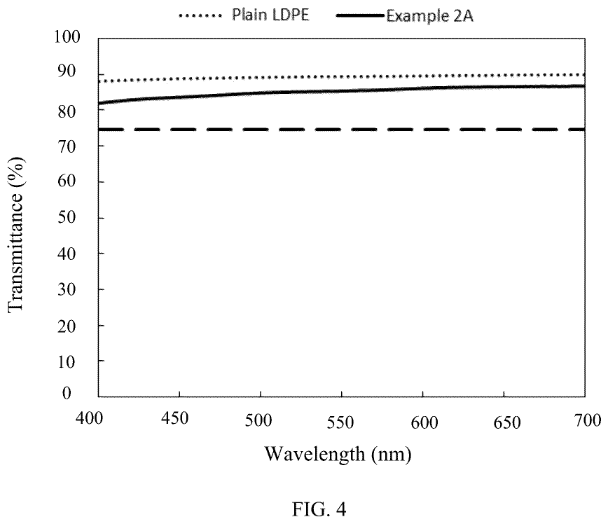

2.5 parts by weight of polyvinyl alcohol (PVA, Mw: 85,000-124,000, degree of hydrolysis: 95.5-96.5%) was mixed with 12.5 part by weight of glycerol. Then 0.6 parts by weight of chitosan (Mw: 50,000-190,000, deacetylated degree: 75-85%) dissolved in acetic acid was added under stirring to obtain a homogeneous mixture M1. 0.5 part by weight of nano clay (particle diameter: 5 to 100 nm) dispersed in 82.6 parts by weight of water and then 1.3 parts by weight of citric acid was added to obtain a mixture M2. The mixture M2 was poured into the mixture M1. The final mixture was homogenized for 2 minutes by using an ultrasound sonicator. Afterwards, the final mixture was further stirred for 3 hours under 80° C. water bath and the coating solution of Example 2 was formed. The coating composition of Example 2 was applied by bar coating on an LDPE film after corona or plasma surface treatment of the film and cured at 80 to 120° C. to form the coated samples of Example 2A. The OTR of Example 2A was reduced by over 98% compared with the plain LDPE without coating as shown in Table 2. The coating layer of Example 2A had an average film thickness of less than 3 m as observed by scanning electron microscope in FIG. 3. The reduction in transmittance in the visible light region of 400 to 700 nm of the Example 2A was less than 15% comparing with plain LDPE without coating as shown in FIG. 4.

TABLE 2
Oxygen transmission rate (OTR) of
plain LDPE film and Example 2A.

| Sample | OTR (cm³/(m² · day)) |
|---|---|
| Plain LDPE | 316.443 |
| Example 2A | 3.385 |

### Preparation of Example 3

2.5 parts by weight of polyvinyl alcohol (PVA, Mw: 85,000-124,000, degree of hydrolysis: 95.5-96.5%) was mixed with 12.5 part by weight of glycerol. Then 0.6 parts by weight of chitosan (Mw: 50,000-190,000, deacetylated degree: 75-85%) dissolved in acetic acid was added under stirring to obtain a homogeneous mixture M1. 0.55 part by weight of nano clay and zinc oxide (particle diameter: 5 to 100 nm) dispersed in 82.6 parts by weight of water and then 1.3 parts by weight of citric acid was added to obtain a mixture M2. The mixture M2 was poured into the mixture M1. The final mixture was homogenized for 2 minutes by using an ultrasound sonicator. Afterwards, the final mixture was further stirred for 3 hours under 80° C. water bath and the coating solution of Example 3 was formed. The coating composition of Example 3 was applied on a PET film by bar coating and cured at 80 to 120° C. to render coated sample of Example 3A. The OTR of Examples 3A was reduced by 99% compared with the plain PET without coating as shown in Table 3. Example 3A exhibited antimicrobial activity against Escherichia coli (ATCC 25922) and Staphylococcus aureus (ATCC 6538) as shown in Table 4.

TABLE 3
Oxygen transmission rate (OTR) of
plain PET film and Example 3A.

| Sample | OTR (cm³/(m² · day)) |
|---|---|
| Plain PET | 61.214 |
| Example 3A | 0.584 |

TABLE 4
Antimicrobial activity of Example 3A on Escherichia coli
(ATCC 25922) and Staphylococcus aureus (ATCC 6538).

| | | | | | | Example | |
|---|---|---|---|---|---|---|---|
| | | | | Control | Control | 3A | |
| | | | | (contact | (contact | (contact | |
| | | | | time: 0 | time: 24 | time: 24 | |
| | | | | hour) | hour) | hour) | |
| | | | Viable | Average | Average | Average | |
| | | Volume | cell count | viable | viable | viable | |
| | | of test | in the | cell | cell | cell | Antimicrobial |
| | | inoculum | added test | count of | count of | count of | activity |
| | | added | inoculum | triplicate | triplicate | triplicate | (log value) |
| Test | Unit | mL | CFU | CFU/test piece | | | Nil |
| organism | LOR | — | 1 | 1 | 1 | 1 | 0.01 |
| species | | | | | | | |
| Escherichia coli | | 0.2 | 430000 | 310000 | 660000 | <1 | >5.82 |
| (ATCC 25922) | | | | | | | |
| Staphylococcus | | 0.2 | 350000 | 190000 | 560000 | <1 | >5.72 |
| aureus (ATCC | | | | | | | |
| 6538) | | | | | | | |

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. The term “substantially coplanar” may refer to two surfaces within a few micrometers (μm) positioned along the same plane, for example, within 10 am, within 5 am, within 1 am, or within 0.5 am located along the same plane. When reference is made to “substantially” the same numerical value or characteristic, the term may refer to a value within ±10%, ±5%, ±1%, or ±0.5% of the average of the values.

In summary, the present invention offers several strengths and advantages compared to prior art solutions, making it a significant breakthrough in the field of oxygen barrier packaging materials.

1. Enhanced Oxygen Barrier Performance: The oxygen barrier coating formed on the substrate polymer transparent and flexible film exhibits an oxygen transmission rate reduction of at least 90% compared to the substrate film without the coating. This exceptional barrier performance effectively prevents oxygen ingress, protecting the packaged contents from oxidation and spoilage. Compared to conventional packaging materials, the present invention provides superior preservation of food and other sensitive products, extending their shelf life and maintaining their freshness for longer periods.

2. High Transparency and Aesthetics: The oxygen barrier coating composition enables the packaging material to maintain excellent light transmissibility, with at least 75 percent of light passing through. This characteristic is crucial for products that rely on visual appeal for marketing and consumer perception. Unlike some prior art solutions, which may compromise transparency when incorporating high levels of clay minerals, the present invention ensures that the packaging maintains its clarity and aesthetics, enhancing product visibility and consumer satisfaction.

3. Stretchability and Flexibility: The oxygen barrier coating is designed to be stretchable and bendable along with the substrate polymer, without compromising its oxygen barrier properties. This flexibility allows for ease of handling during packaging manufacturing processes, such as forming and sealing. Additionally, the packaging material's ability to conform to different shapes and contours makes it ideal for a wide range of product packaging applications.

4. Sustainable and Environmentally Friendly: Unlike certain prior art methods that use barrier materials containing potentially harmful chemicals or metals, the composition of the present invention is more environmentally friendly. The absence of chlorine-containing compounds, as seen in some conventional barrier materials, reduces the risk of dioxin emission during disposal. Furthermore, the composition can be formulated using biodegradable and eco-friendly components, contributing to a more sustainable packaging solution and reducing environmental impact.

5. Versatility in Composition: The oxygen barrier coating composition allows for various formulations, including different coating polymers, nanoparticles, plasticizers, and crosslinking agents. This flexibility enables the tailoring of the barrier material to meet specific product requirements, such as the desired level of barrier performance and compatibility with various packaging substrates. By adjusting the composition, the present invention can cater to a diverse range of products, industries, and packaging formats.

6. Incorporation of Additional Functionalities: The composition of the oxygen barrier coating can accommodate the addition of functional agents, such as UV-absorbing agents, and colorants. These additives further enhance the packaging material's overall performance and functionality. For instance, the inclusion of UV-absorbing agents protects the packaged products from harmful UV radiation, preventing degradation and preserving their quality. Colorants allow for customized and attractive packaging designs, enabling effective branding and product differentiation.

Overall, the present invention represents a substantial advancement in oxygen barrier packaging materials, offering improved performance, visual appeal, and environmental consciousness compared to prior art solutions. Its unique combination of properties makes it an attractive and viable option for a wide range of packaging applications across various industries.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. An oxygen barrier packaging material, comprising:
a substrate polymer transparent and flexible film; and
an at least 75 percent light transmissive, oxygen barrier coating formed on the substrate polymer transparent and flexible film, the oxygen barrier coating formed from a composition comprising:
approximately 15 wt % to 35 wt % of a coating polymer in dry weight;
approximately 0.1 wt % to 5 wt % of nanoparticles in dry weight;
approximately 40 wt % to 75 wt % of a plasticizer in dry weight; and
approximately 5 wt % to 20 wt % of a crosslinking agent in dry weight;
wherein the nanoparticles in the coating create a convoluted path for oxygen and the coating is stretchable and bendable with the substrate polymer.

2. The oxygen barrier packaging material of claim 1, wherein the coating polymer is selected from chitosan with a molecular weight from 50,000 to 190,000, polyvinyl alcohol with a molecular weight from 85,000 to 130,000 and a degree of hydrolysis from 90% to 99% or a combination thereof.

3. The oxygen barrier packaging material of claim 1, wherein the nanoparticles are selected from silicon dioxide, zinc oxide, nano clay or combinations thereof, and the nanoparticles have a particle diameter of 5 nm to 100 nm.

4. The oxygen barrier packaging material of claim 1, wherein the plasticizer is selected from glycerol, sorbitol or the combination thereof.

5. The oxygen barrier packaging material of claim 1, wherein the crosslinking agent is selected from citric acid, malic acid, maleic acid, tartaric acid or combinations thereof.

6. The oxygen barrier packaging material of claim 1, wherein the coating is formed from a coating solution comprising the coating composition of claim 1 and a solvent, wherein a weight ratio of the coating composition to the solvent is 1:1 to 1:15.

7. The oxygen barrier packaging material of claim 6, wherein the solvent is selected from distilled water, deionized water, methanol, ethanol, acetone, ether, or combinations thereof.

8. The oxygen barrier packaging material of claim 1, wherein the packaging material exhibits a reduction in oxygen transmission rate of at least 90% compared to the substrate polymer transparent and flexible film without the oxygen barrier coating.

9. The oxygen barrier packaging material of claim 1, wherein the oxygen barrier coating has a dry coating thickness approximately 3 μm or less.

10. The oxygen barrier packaging material of claim 1, wherein the substrate polymer transparent and flexible film is polyethylene terephthalate or a low-density polyethylene.

11. The oxygen barrier packaging material of claim 1, wherein the composition further comprises a UV-absorbing agent in a weight percentage of approximately 0.1 wt % to 5 wt % of the dry weight, and a colorant in a weight percentage of approximately 0.1 wt % to 5 wt % of the dry weight.

12. The oxygen barrier packaging material of claim 1, wherein the substrate polymer transparent and flexible film further comprises a print or pattern on its surface, wherein the print or pattern is applied using a printing process selected from flexographic printing, gravure printing, or digital printing.

13. A method of manufacturing the oxygen barrier packaging material of claim 1, comprising:
coating the substrate polymer transparent and flexible film with a coating solution comprising the coating composition of claim 1 and a solvent;
drying the coated film to form the oxygen barrier coating on the substrate polymer transparent and flexible film; and
curing the oxygen barrier coating by heat treatment of 80° C. to 120° C.

14. An oxygen barrier coating composition comprising:
approximately 15 wt % to 35 wt % of a coating polymer in dry weight;
approximately 0.1 wt % to 5 wt % of nanoparticles in dry weight;
approximately 40 wt % to 75 wt % of a plasticizer in dry weight; and
approximately 5 wt % to 20 wt % of a crosslinking agent in dry weight;
wherein the nanoparticles in the coating create a convoluted path for oxygen when the coating composition is disposed on a substrate and wherein the formed coating is bendable and stretchable.

15. The oxygen barrier coating composition of claim 13, wherein the coating polymer is selected from chitosan with a molecular weight from 50,000 to 190,000, polyvinyl alcohol with molecular weight from 85,000 to 130,000 and a degree of hydrolysis from 90% to 99% or a combination thereof.

16. The oxygen barrier coating composition of claim 13, wherein the nanoparticles are selected from silicon dioxide, zinc oxide, nano clay or combinations thereof, and the nanoparticle has a particle diameter of 5 nm to 100 nm.

17. The oxygen barrier coating composition of claim 13, wherein the plasticizer is selected from glycerol, sorbitol or the combination thereof.

18. The oxygen barrier coating composition of claim 13, wherein the crosslinking agent is selected from citric acid, malic acid, maleic acid, tartaric acid or combinations thereof.

19. The oxygen barrier coating composition of claim 13, wherein the coating is formed into a coating solution comprising the coating composition of claim 12 and a solvent, wherein a weight ratio of the coating composition to the solvent is 1:1 to 1:15.

20. The oxygen barrier coating composition of claim 18, wherein the solvent is selected from distilled water, deionized water, methanol, ethanol, acetone, ether, or combinations thereof.
